(19) United States
(12) Patent Application Publication
(10) Pub. No.: US 2004/0078712 A1
(43) Pub. Date: Apr. 22, 2004

(54) Method and apparatus for stressing data paths

(76) Inventors: Gurushankar Rajamani, Sunnyvale, CA (US); Kent Dickey, Westford, MA (US); Robert Shaw, Sunnyvale, CA (US); Mark E. Shaw, Plano, TX (US); Daniel Li, Saratoga, CA (US)

Correspondence Address: HEWLETT-PACKARD COMPANY, Intellectual Property Administration, P.O. Box 272400, Fort Collins, CO, 80527-2400, US

(21) Appl. No.: 10/241,789

(22) Filed: Sep. 12, 2002

(51) Int. Cl. G06F 11/00

(52) U.S. Cl. 714/43

(57) ABSTRACT

The present invention generally relates to the testing of computer systems by moving data from one location to another. More particularly, the present invention relates to a method for stressing the data paths of computer systems by increasing data traffic throughout the computer system without increasing checking overhead.

### FIELD OF THE INVENTION

The present invention generally relates to the testing of computer systems by moving data from one location to another. More particularly, the present invention relates to a method for stressing the data paths of computer systems by increasing data traffic throughout the computer system without increasing checking overhead.

### BACKGROUND OF THE INVENTION

In testing computer systems, a test tool should be able to test a given system architecture in an idle state, at maximum capacity, and everything in between. As can be appreciated, a crucial part of hardware testing involves “stressing” the system, or pushing the system to its maximum capacity, in order to assess its performance under these extreme conditions. A subset of these tests involves creating maximum data movement, stressing the various paths, while not modifying the data in any way.

In tests of this sort, a successful test is one in which at the test's end the data has no modifications, but merely resides in a new location in the computer system. If there are modifications to the data, this is a sign of a bug in the computer hardware, which can then be pinpointed and corrected using methods known to those skilled in the art.

A test of data movement is performed as follows. First, the test is set up. The set-up stage is performed once for each given software configuration, regardless of how many times the test is run. The tester decides what operations every device in the system needs to carry out (including the processors, PCI cards, etc.), programs the agents (generally PCI cards) to run the test according to his aforementioned decisions, and calculates what the end results of the test should be.

Second the test is run. Last, the observed results are checked, by comparing them to the precalculated theoretical results. Generally, the PCI cards are programmed to copy from at least one memory location to at least one memory location, where these memory locations are in the main memory of the computer system, not in the PCI cards' internal memory. This generates data traffic on the PCI bus, the chip set buses, the processor bus, and the memory bus. These last two stages are performed every time the test is run.

In most computer systems, PCI buses feed into and out of chipset buses, which in turn feed into and out of memory buses, processor buses, and so on. An operation in which a PCI card moves a number of bytes from one location to another in the system's main memory will generate data traffic on the PCI bus, buses to the chip set, the processor bus, and the memory bus. This is almost all of the buses in most systems. Thus, stressing the PCI bus (through tests like that described above) stresses almost every bus in the computer system. This method of testing is used to test computer systems from those of servers with 1 or 2 processors and a few PCI buses, to those of massive machines with 64 processors and 100's of PCI buses.

At present the test is set up as follows. Let sₙ, dₙ, szₙ be the source address, the destination address, and the size, respectively, of the data block to be moved in data movement n. A first PCI card is programmed to move sz₁ bytes from s₁ to d₁, SZ₂ bytes from S₂ to d₂, and so on and so forth. Some other number of the PCI cards in the computer system being tested are similarly programmed.

The test is then run with this programming, such that the various data movements occur with maximal temporal proximity, stressing the system's data paths. FIG. 1 shows an example set of data movements 100 to be executed by the computer system when the test is run.

The checks performed at the end of each test are a) that the source data is unchanged, and b) that the data at each destination addresses matches the data at the respective source address. Column 120 shows the steps involved in check a; column 140 shows the steps involved in check b.

The time to run each test is the time for the data movement, plus the time for the data checking. According to the current method of testing, for every q bytes moved, 2q bytes must be checked (q bytes in each of checks a and b).

The first of these steps requires very little time per byte, as the data movement is done at the hardware level. The second step, however, demands relatively large per byte overhead times, as the comparison of the data is typically done at the software level, which is several orders of magnitude slower than hardware. One estimate given by HP is that more than 50% of testing time is taken by data checking.

Furthermore, due to the nature of modern computer systems, hardware tests are notoriously difficult to reproduce. While any two tests run with the same software configuration (i.e. programming) will be the same at the software level, there is no practical way to guarantee that they will be the same at the hardware level. The high number and complexity of hardware components in a computer system means that the order of magnitude of possible hardware combinations for the same set of software instructions can range from the thousands to the millions to a potentially infinitely large number. In order to generate the same hardware combination that caused a given bug in the test results, it is necessary to test the same software configuration on average a number of times equal to the number of possible hardware combinations. At current testing rates of approximately 200 tests/second, this means that testing for each bug can take as long as 6-8 hours. This illustrates the desirability of being able to carry out greater numbers of tests in less time.

A need therefore exists for a method for stressing computer systems which will maximize the number of bytes of data moved per test, while minimizing the number of bytes checked per test.

### GLOSSARY OF TERMS USED IN THE INVENTION

The following definitions relate to these terms as they are used herein:

“Transmission medium”—any type of hardware used for transmitting carrier signals from one logic circuit to another, including, but not limited to, a bus (such as a PCI or processor bus), a telephone line, a network cable, a wireless transmission system (including infrared), or any other medium capable of sending and receiving electrical, electromagnetic, or optical signals which carry digital data streams representing various types of information.

“Data path”—the totality of the path along which data is sent, including the various transmission media enroute, as well as control and routing chips or circuits, and any other piece of hardware or software involved in moving the data from one location to another.

“Memory means”—any computer hardware component capable of storing data, where the data does not change regardless of how many times the component is accessed.

“Memory location”—a physical or logical location of data in a memory means. Any two different memory locations can be located in the same physical memory means, or the two different memory locations can be located in two different physical memory means.

“Sequentially consistent”—data processing is sequentially consistent when all instructions corresponding to access operations (i.e. reading and writing) performed on a particular memory location by a given agent on the data path are executed in the order the instructions are issued.

For example, as illustrated by FIG. 2, if a PCI card issues an instruction 200 to perform a read on memory location A, an instruction 210 to perform a write operation on memory location B, and then an instruction 220 to perform a read operation on memory location B, instructions 210 and 220 must be executed in that order for the data processing to be sequentially consistent. If the instruction 220 to perform a read operation on memory location B is executed before the instruction 210 to perform the write operation on memory location B is executed, the data processing is not sequentially consistent. The result of such non-sequentially consistent data processing would be that when the read operation is performed on memory location B according to instruction 220, it would be reading the value in memory location B from before the write operation to memory location B according to instruction 210, and not the value written to memory location B, as intended.

### SUMMARY OF THE INVENTION

It is, therefore, an object of the present invention to improve the testing of a computer system with a method that will stress the computer system by maximizing traffic on the system's data paths, while at the same time minimizing the total amount of data which must be checked at the end of each test.

It is another object of the present invention to improve the testing of a computer system whose specific architecture is such that the operation of moving a set of data from one location in main memory to another, by means of a PCI bus, will involve most of the hardware in the chipset/control, with a method that will stress the computer system by maximizing data traffic on the PCI bus, while at the same time minimizing the total amount of data which must be checked at the end of each test.

According to the present invention, a method is disclosed for stressing and testing a data path. A certain set of data is designated as source data and is stored for later steps. This source data is sent along the data path from a first location to a second location. The data is received and stored at the second location. The next steps are then repeated in a loop: The received data is then sent along the data path from the second location to the first location. The data is received and stored at the first location. The received data is then sent along the data path from the first location to the second location. The data is received and stored at the second location. This marks the end of the loop. These steps are performed repeatedly at a rate sufficient to stress the data path.

When the loop is finished, the last data received and stored at the first location and the last data received and stored at the second location are compared to each other and to the source data which was stored in the first step of the method. The results of this comparison are then outputted.

According to the present invention, a second method is disclosed for stressing and testing a data path. A certain set of data is designated as source data. The source data is sent along the data path from a first location to a second location. The data is received and stored at the second location. This sending, receiving, and storing of the source data is repeated at a high enough rate to stress the data path.

When the loop is finished, the last data received and stored at the second location is compared to the source data. The results of this comparison are outputted

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

FIG. 1 is a flow chart illustrating the method of the prior art for stress testing data paths;

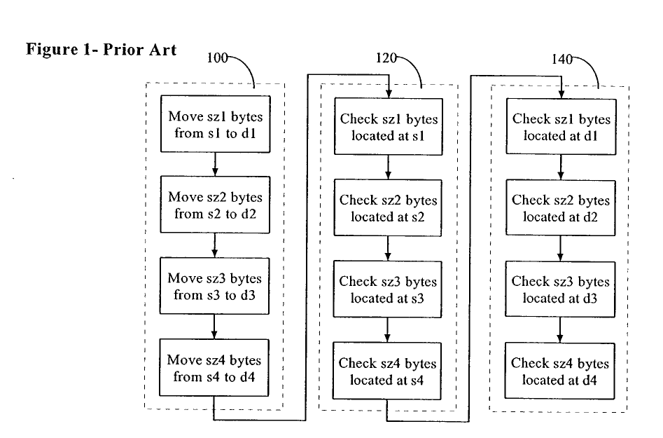

FIG. 2 is a flow chart illustrating the concept of sequential consistency;

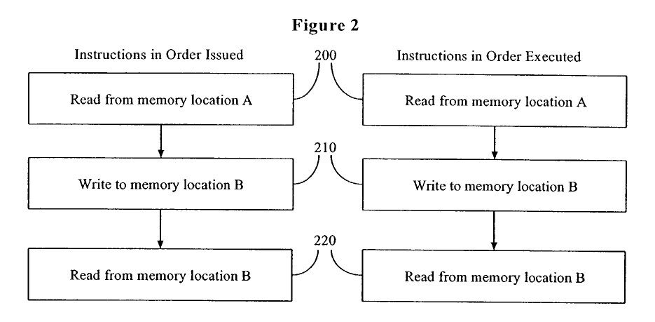

FIG. 3 is a block diagram of a computer system whose data path would be stress tested by both the prior art and the present invention;

FIG. 4 is a flow chart illustrating a first method disclosed in the present invention for stress testing data paths.

FIG. 5a is a flow chart illustrating a second and preferred method disclosed in the present invention for stress testing data paths; and

FIG. 5b is a flow chart illustrating an alternative embodiment to the data movement stage of the flow chart in FIG. 5a.

### BEST MODE FOR CARRYING OUT THE INVENTION

A first and second methods for stress testing data paths of a computer system are described. In the following description, for purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

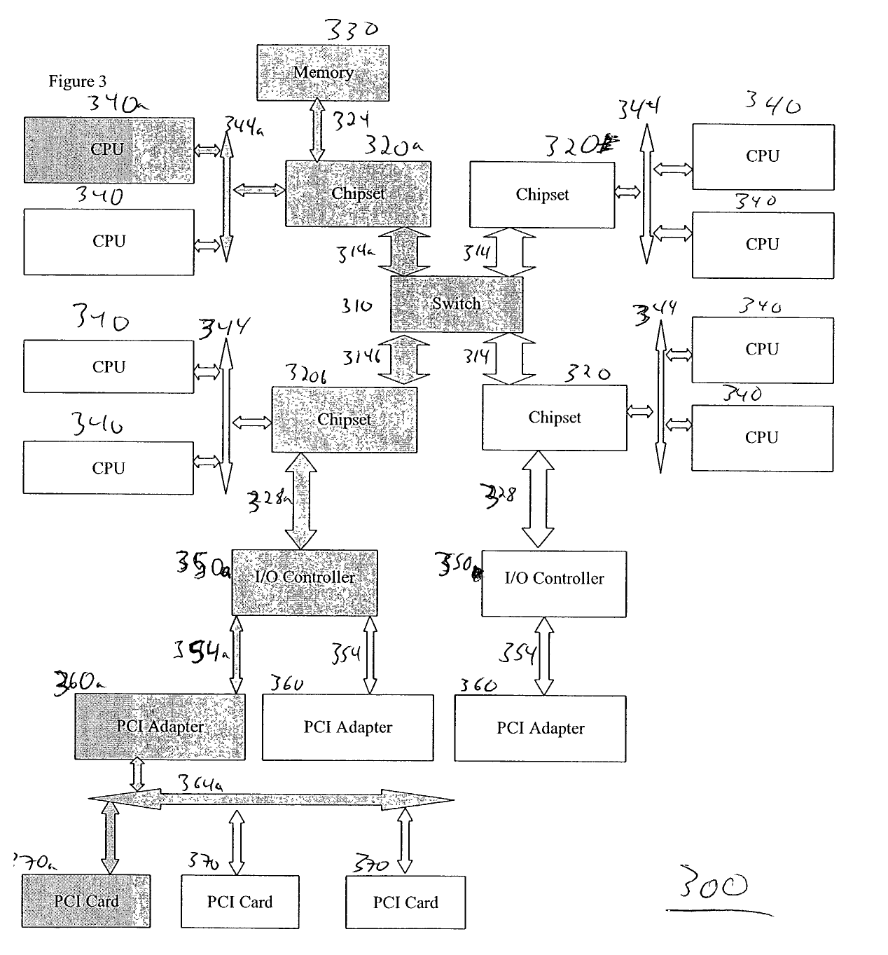

FIG. 3 is a block diagram of an exemplary computer system 300 whose data path would be stress tested by both the prior art and the present invention. The computer system includes one or more switches 310, communicating by chipset buses 314 with one or more chipsets 320. Each chipset 320 communicates with one or more memory means 330 by means of a memory bus 324. Each chipset also communicates with one or more CPU's 340 by means of a CPU bus 344.

Each chipset 320 also communicates with an I/O controller 350 by means of an I/O bus 328. Each I/O controller communicates with one or more PCI adapters 360 by means of a PCI adapter bus 354. Each PCI adapter 360 communicate with one or more PCI cards 370 by means of a PCI bus 364.

The computer system as illustrated by FIG. 3 is only one of many possible system architectures to which the methods of the present invention could be applied. Additionally, multiple switches can be made to communicate with each other, such that entire computer system 300 could be expanded by a factor of itself.

According to the exemplary architecture of FIG. 3, a read-from-memory operation would cause data traffic as follows (components which receive traffic are shaded in with gray on the drawing). PCI card 370a would issue the instruction across PCI bus 364a to PCI adapter 360a, which would send the instruction across PCI adapter bus 354a to I/O controller 350a, which would send the instruction across I/O bus 328a to chipset 320b. Assuming that the memory location specified in the read-from-memory instruction is not connected directly to chipset 320b, chipset 320b would send the instruction across chipset bus 314b to switch 310. Switch 310 would determine which chipset is connected to the memory location specified, and route the data accordingly. If the memory location was in memory 330, for example, switch 310 would send the instruction across chipset bus 314a to chipset 320a. If the memory location is cached in CPU memory, for example that of CPU 340a, chipset 320a will send the instruction across CPU bus 344a to the CPU (in the example CPU 340a). If the memory location is not cached in CPU memory, chipset 320a will send the instruction across memory bus 324 to memory 330.

From the memory location read, whether it is in CPU 340a or memory 330, the data will flow back to PCI card 370a in the reverse order of the path along which the instruction was sent.

A write-to-memory operation issued by PCI card 370a will create the same data traffic as a read-from-memory operation at the same memory location.

As used herein, let sₙ, dₙ, szₙ be the source address, the destination address, and the size, respectively, of the data block to be moved in data movement n.

Most PCI cards can read and write to system memory. The PCI card 370a can be programmed to transfer data. This is because the PCI cards have to interact with the external interfaces (fibrechannel, ethernet, SCSI, a mike, a speaker, etc.). This involves the CPU sending or receiving some data to and from the interface. While it is possible that the PCI card can have internal memory that the PCU can access and communicate through, currently all cards use DMA's (direct memory access) where they have the ability to read and write the system memory.

Only some cards can do loopbacks meaning they can read some data from some address A and write the same data to address B. This is because loopbacks are rarely required by PCI cards except as a debug feature since PCI cards are an interface between the CPU and an outside interface. This loopback feature is required for our testing. The loopback capability is present, for example, in SCSI cards, fibrechannel and ATM cards. Some gigabit ethernet cards have the capability, but presently it is too slow.

There are some PCI based DMA engines in the market which basically offload some of the large copying jobs from the processor. These engines are ideal for our testing since loopbacks are the only function these cards perform.

PCI cards can also perform the checking. However, production cards do not have this feature. There are specialized cards in he market which are called PCI/PCI-X exercisers. These cards can be programmed to run tests through the PCI bus. They do have some checking features. The current generation of cards are notoriously slow (a test takes about two seconds or so) and is expensive as opposed to regular SCSI cards which are considerably faster and less expensive.

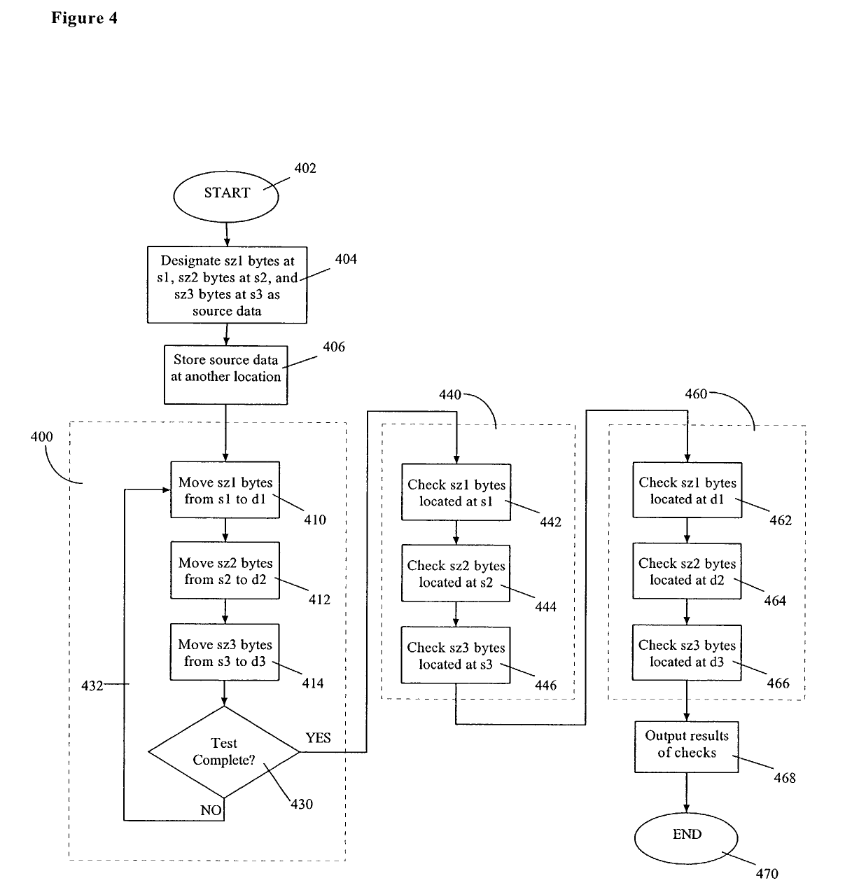

FIG. 4 is a flow chart illustrating the first method which served as an intermediary step in the development of the second and preferred method for stressing data paths in the present invention. The first method includes a data movement stage 400, and two data checking stages 440 and 460. All of the steps disclosed in the data movement stage 400 are first programmed into the PCI cards, in the manner previously described.

The method starts at a starting step 402. At step 404 sz1 bytes at memory location s1, sz2 bytes at memory location s2, and sz3 bytes at memory location s3 are designated as source data. At step 406 the source data is stored at another location, which is not accessed again until the data checking steps 440 and 460. The data movement stage or loop 400 is entered into from step 406. Starting the data movement loop 400 at step 410, sz1 bytes are moved from memory location sl to memory location d1. At step 412, sz2 bytes are moved from memory location s2 to memory location d2. At step 414, sz3 bytes are moved from memory location s3 to memory location d3.

At step 430, a predetermined condition, such as an amount of elapsed time or a number of loop iterations, is tested. If the predetermined condition is true, indicating that the test is complete, the method progresses to the data checking stage 440. If the predetermined condition is false, indicating that the test is not complete, the method goes back to step 410, which is the first step of the data movement stage 400.

In the data checking stage 440, the data stored at the source memory locations is checked against the respective source data stored at another location in step 406, to verify that it is unchanged. In step 442 sz1 bytes are checked at memory location s1. In step 444 sz2 bytes are checked at memory location s2. In step 446 sz3 bytes are checked at memory location s3.

In data checking stage 460, the data stored at the destination memory locations is checked to verify that it is the same as the data stored at the respective source memory locations. In step 462 sz1 bytes are checked at memory location d1. In step 464 sz2 bytes are checked at memory location d2. In step 466 sz3 bytes are checked at memory location d3.

In step 468 the results of the checks in data checking stages 440 and 460 are outputted.

Step 470 indicates the end of the method. If x loops of the data movement stage 400 were executed, and q equals the sum of sz1, sz2, and sz3, then the total amount of data moved equals xq. The total number of bytes which must be checked at the end of the test is 2q (q bytes in each of checking stages 440 and 460). As x can be set arbitrarily high, the stated goal of maximizing traffic on the system's data paths, while at the same time minimizing the total amount of data which must be checked at the end of each test, is achieved.

The method illustrated by the flow chart of FIG. 4 has the disadvantage that if there is an error in the data movement during any of the loops through the data movement stage 400 except for the last loop, and then on the last loop there is no error, there will be no record of the error. In other words, only the data movement which occurred in the last loop of the data movement loop 400 will be recorded in s1, s2, s3, d1, d2, and d3. This is, therefore, an effective method of stressing the data path, but has a serious drawback in terms of its ability to test the correctness of data movement. It can be effectively used to stress the data path, but it must be combined with the method of the prior art to effectively test the correctness of data movement.

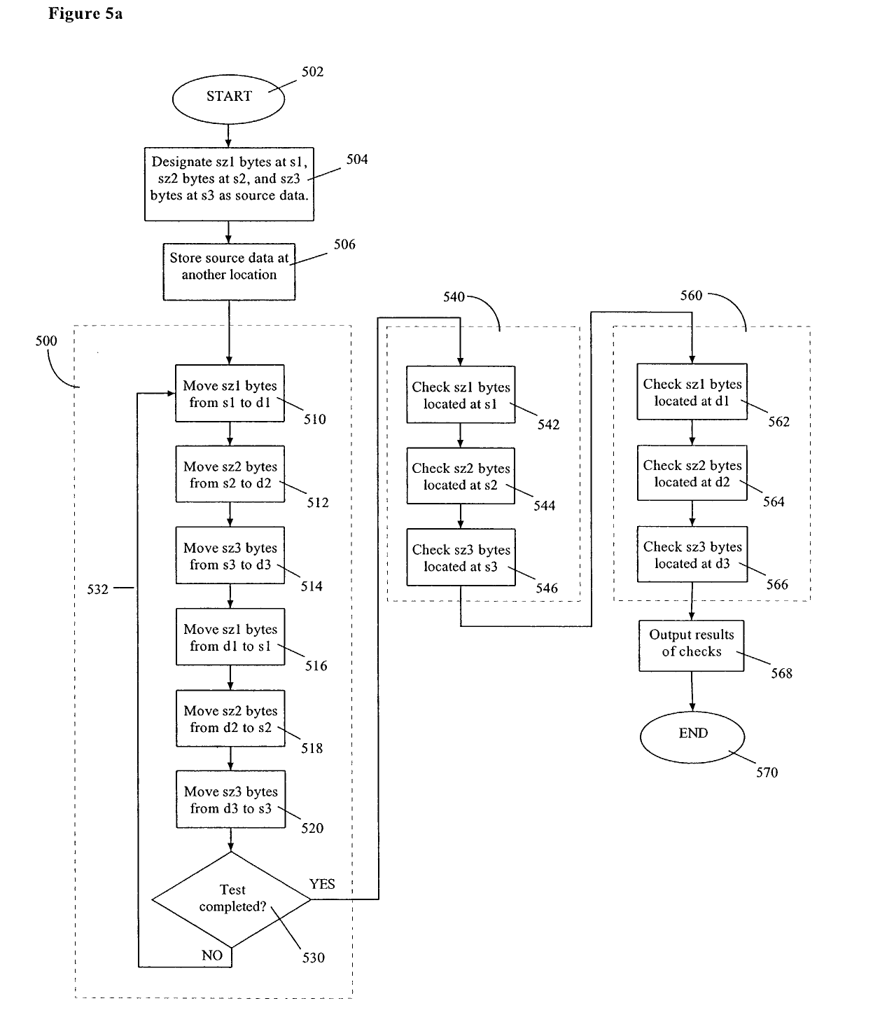

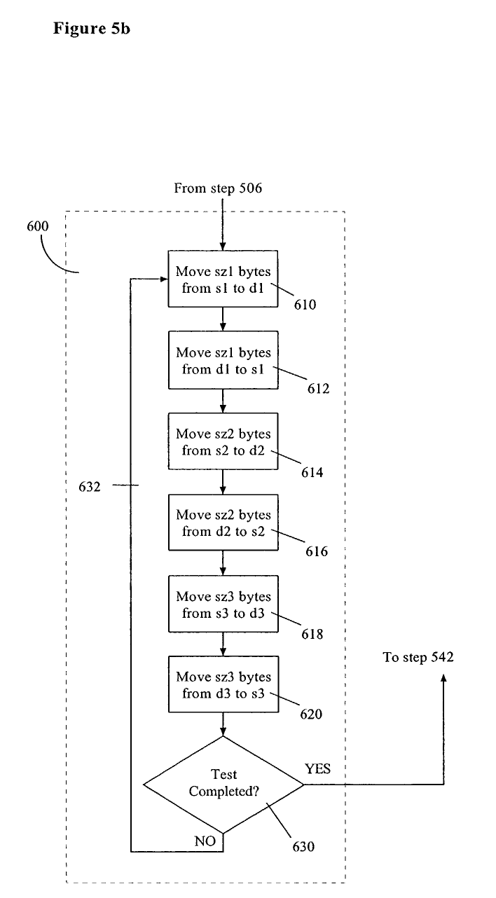

The flow charts of FIGS. 5a and 5b illustrate a second and preferred method which is an improvement over the method illustrated in the flow chart of FIG. 4. The method and testing the correctness of data movement, without any combination with the prior art.

This method includes a data movement stage 500, and two data checking stages 540 and 560. All of the steps disclosed in the data movement stage 500 are first programmed into the PCI cards, in the manner previously described.

The method starts at a starting step 502. At step 504 sz1 bytes at memory location s1, sz2 bytes at memory location s2, and sz3 bytes at memory location s3 are designated as source data. At step 506 the source data is stored at another location, which is not accessed again until the data checking steps 540 and 560. The data movement stage or loop 500 is entered into from step 506. Starting the data movement loop 500 at step 510, sz1 bytes are moved from memory location sI to memory location d1. At step 512, sz2 bytes are moved from memory location s2 to memory location d2. At step 514, sz3 bytes are moved from memory location s3 to memory location d3.

At step 516, sz1 bytes are moved from memory location d1 to memory location s1. At step 518, sz2 bytes are moved from memory location d2 to memory location s2. At step 520, sz3 bytes are moved from memory location d3 to memory location s3.

It is important to note that steps 516, 518, and 520 are not executed before the completion of steps 510, 512, and 514, respectively.

At step 530, a predetermined condition, such as an amount of elapsed time or a number of loop iterations, is tested. If this condition is true, indicating that the test is complete, the method progresses to the data checking stage 540. If this condition is false, indicating that the test is not complete, the method goes back to step 510, which is the first step of the data movement loop 500.

In data checking stage 540, the data stored at the source memory locations is checked against the respective source data stored at another location in step 506, to verify that it is unchanged. In step 542 sz1 bytes are checked at memory location s1. In step 544 sz2 bytes are checked at memory location s2. In step 546 sz3 bytes are checked at memory location s3.

In data checking stage 560, the data stored at the destination memory locations is checked to verify that it is the same as the data stored at the respective source memory locations. In step 562 sz1 bytes are checked at memory location d1. In step 564 sz2 bytes are checked at memory location d2. In step 566 sz3 bytes are checked at memory location d3.

In step 568 the results of the checks in data checking stages 540 and 560 are outputted.

Step 570 indicates the end of the method. If x loops of the data movement stage 500 were executed, and q equals the sum of sz1, sz2, and sz3, then the total amount of data moved equals 2xq. The total number of bytes which must be checked at the end of the test is 2q (q bytes in each of checking stages 540 and 560). As x can be set arbitrarily high, the stated goal of maximizing traffic on the system's data paths, while at the same time minimizing the total amount of data which must be checked at the end of each test, is achieved.

Additionally, as differentiated from the method illustrated by the flow chart of FIG. 4, if there is an error in the data movement during any of the loops through the data movement stage 500, this error will be perpetuated throughout the test and will be detected in at least one of data checking stages 540 and 560.

FIG. 5b is a flow chart illustrating an alternative data movement stage which can be used in lieu of data movement stage 500. The data movement stage or loop 600 is entered into from starting step 502. Starting the data movement loop 600 at step 610, sz1 bytes are moved from memory location s1 to memory location d1. At step 612, sz1 bytes are moved from memory location d1 to memory location s1.

At step 614, sz2 bytes are moved from memory location s2 to memory location d2. At step 616, sz2 bytes are moved from memory location d2 to memory location s2.

At step 618, sz3 bytes are moved from memory location s3 to memory location d3. At step 620, sz3 bytes are moved from memory location d3 to memory location s3.

It is important to note that steps 612, 616, and 620 are not executed before the completion of steps 610, 614, and 618, respectively. That is to say, steps 610-620 are executed in a sequentially consistent manner.

At step 630, a predetermined condition, such as an amount of elapsed time or a number of loop iterations, is tested. If this condition is true, indicating that the test is complete, the method progresses to the data checking stage 540, entering into step 542. If this condition is false, indicating that the test is not complete, the method goes back to step 610, which is the first step of the data movement loop 600.

The data movement stage or loop 500 of FIG. 5a and the data movement stage or loop 600 of FIG. 5b are almost identical; however, data paths were observed to behave differently depending on which one was used in the second and preferred method according to the present invention.

It should now be apparent that a method has been described for stressing a computer system by maximizing traffic on the computer system's data paths, while at the same time minimizing the total amount of data which must be checked at the end of each test.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

It is claimed:

1. A method for stressing and testing a data path comprising the following steps:
(a) designating and storing a certain set of data as source data;
(b) sending the source data along the data path from a first location to a second location and receiving the sent source data at the second location, and storing the received data at the second location;
(c) sending the stored received source data from the second location along the data path to the first location and receiving the stored received source data at the first location and storing the stored received source data at the first location;
(d) sending the stored received source data from the first location to the second location and receiving the sent stored received source data at the second location, and storing the received data at the second location;
(e) repeating steps (c)-(d) at a high enough rate to stress the data path;
(f) at the conclusion of either steps (c) or (d) comparing the stored received data at the first location and the second stored received data at the second location to each other and to the source data stored in step (a);
(g) outputting the results of the comparisons of step (f).

2. The method of claim 1, wherein data sent on the data path is processed in a sequentially consistent manner.

3. The method of claim 1, wherein the data path includes a PCI bus connected to other buses, in such a manner that creating data traffic on the PCI bus creates data traffic on the other buses.

4. The method of claim 1, wherein said step (b) of storing the received data at the second location includes the step of storing said received data in a memory means, said step (c) of storing the received data at said second location includes the step of storing said received data in a memory means, and said step (d) of storing the received data at the second location includes the step of storing said received data in a memory means.

5. The method of claim 1, wherein the data path is either a physical or logical loop, such that the first location and the second location are two locations within the same logical component.

6. A method for stressing and testing a data path comprising the following steps:
(a) designating and storing a certain set of data as source data;
(b) sending the source data along the data path from a first location to a second location, receiving the sent data at the second location, and storing the received data at the second location;
(c) repeating step (b) at a high enough rate to stress the data path;
(d) at the conclusion of step (c), comparing the received data at the second location to the source data stored in step (a);
(e) outputting the results of the comparisons of step (d).

7. The method of claim 6, wherein the data path includes a PCI bus connected to other buses, in such a manner that creating data traffic on the PCI bus creates data traffic on the other buses.

8. The method of claim 6, wherein said step (b) of storing the received data at the second location includes the step of storing said received data in a memory means.

9. The method of claim 6, wherein the data path is either a physical or logical loop, such that the first location and the second location are two locations within the same logical component.

10. A computer architecture for stressing and testing a data path, comprising:
designating means for designating and storing a certain set of data as source data;
sending means for sending the source data along the data path from a first location to a second location and receiving the sent source data at the second location, and storing the received data at the second location;
sending means for sending the received data from the second location along the data path to the first location and receiving the sent data at the first location, and storing the received sent data at the first location;
sending means for sending the stored received data from the first location to the second location and receiving the sent data at the second location, and storing the received data at the second location;
comparing means for comparing the stored received data at the first location and the stored received data at the second location to each other and to the source data; and
outputting means for outputting the results of the comparisons.

11. A computer system, comprising:
a processor; and
a memory coupled to said processor, the memory having stored therein sequences of instructions, which, when executed by said processor, causes said processor to perform the steps of:
(a) designating and storing a certain set of data as source data;
(b) sending the source data along the data path from a first location to a second location and receiving the sent source data at the second location, and storing the received data at the second location;
(c) sending the stored received source data from the second location along the data path to the first location and receiving the sent stored received source data at the first location, and storing the received source data at the first location;
(d) sending the stored received source data from the first location to the second location and receiving the sent stored received source data at the second location, and storing the received data at the second location;
(e) repeating steps (c)-(d) at a high enough rate to stress the data path;
(f) at the conclusion of either steps (c) or (d) comparing the stored received data at the first location and the second stored received data at the second location to each other and to the source data stored in step (a);
(g) outputting the results of the comparisons of step (f).

12. The computer system of claim 11, wherein data sent on the data path is processed in a sequentially consistent manner.

13. The computer system of claim 11, wherein the data path includes a PCI bus connected to other buses, in such a manner that creating data traffic on the PCI bus creates data traffic on the other buses.

14. The computer system of claim 11, wherein said step (b) of storing the received data at the second location includes the step of storing said received data in a memory means, said step (c) of storing the received data at said second location includes the step of storing said received data in a memory means, and said step (d) of storing the received data at the second location includes the step of storing said received data in a memory means.

15. The computer system of claim 11, wherein the data path is either a physical or logical loop, such that the first location and the second location are two locations within the same logical component.

16. A computer readable medium having stored thereon a plurality of sequences of instructions, said plurality of sequences of instructions including sequences of instructions which, when executed by a processor, cause said processor to perform the steps of:
(a) designating and storing a certain set of data as source data;
(b) sending the source data along the data path from a first location to a second location and receiving the sent source data at the second location, and storing the received data at the second location;
(c) sending the stored received source data from the second location along the data path to the first location and receiving the sent stored received source data at the first location, and storing the received source data at the first location;
(d) sending the stored received source data from the first location to the second location and receiving the sent stored received source data at the second location, and storing the received data at the second location;
(e) repeating steps (c)-(d) at a high enough rate to stress the data path;
(f) at the conclusion of either steps (c) or (d) comparing the stored received data at the first location and the second stored received data at the second location to each other and to the source data stored in step (a);
(g) outputting the results of the comparisons of step (f).

17. The computer readable medium of claim 16, wherein data sent on the data path is processed in a sequentially consistent manner.

18. The computer readable medium of claim 16, wherein the data path includes a PCI bus connected to other buses, in such a manner that creating data traffic on the PCI bus creates data traffic on the other buses.

19. The computer readable medium of claim 16, wherein said step (b) of storing the received data at the second location includes the step of storing said received data in a memory means, said step (c) of storing the received data at said second location includes the step of storing said received data in a memory means, and said step (d) of storing the received data at the second location includes the step of storing said received data in a memory means.

20. The computer readable medium of claim 16, wherein the data path is either a physical or logical loop, such that the first location and the second location are two locations within the same logical component.
